(19) United States
(12) Patent Application Publication
(10) Pub. No.: US 2010/0007711 A1
(43) Pub. Date: Jan. 14, 2010

(54) vPhone (video phone), V3Phone (video, voice,vehicular phone) and V3Phone Console for vehicular and portable wireless communication,entertainment, global positioning, and video conferencing

(76) Inventor: Thurmond Bell, Manor, TX (US)

Correspondence Address: Thurmond Bell, 12208 Kilmartin Lane, Manor, TX, 78653, US

(21) Appl. No.: 12/220,295

(22) Filed: Jul. 23, 2008

Related U.S. Application Data
(60) Provisional application No. 61/080,355, filed on Jul. 14, 2008.

(51) Int. Cl. H04N 7/14

(52) U.S. Cl. 348/14.02; 348/E07.078

(57) ABSTRACT

Wireless vPhone series of products: vPhone, v³Phone Console and v³Phone. vPhone (video phone) is a handheld phone with an external connector that connects (via external cable) to a vehicular/portable console (v³Phone Console) or other devices that will provide a larger display screen for viewing LiveTV, Videos, Music, GPS mapping, Voicemail, Games, and other features of the connected/associated vPhone. The vPhone subscriber's wireless subscription information (includes telephone number) and stored data (voicemail, photos, videos, music, etc) is transferred to the v³Phone Console. All data transferred to the v³Phone Console can be automatically erased once the connected/associated vPhone is removed or when another vPhone is connected/associated. The v³Phone Console will become the cell phone (vphone) remote console of the User who connects his/her personal vPhone to it. The v³Phone is a stand-a-lone, complete cell phone unit that does not need to be connected to vPhone, and will require separate Wireless Carrier subscription for wireless services. Both will operate on vehicle power and/or a rechargeable battery for portable operation.

### CROSS REFERENCE TO RELATED APPLICATIONS

This patent application claims priority to U.S. provisional patent application No. 61/080,355, filed Jul. 14, 2008, which is hereby incorporated by reference.

### STATEMENT OF FEDERALLY SPONSORED RESEARCH/DEVELOPMENT

This invention was not federally sponsored.

### BACKGROUND OF INVENTION

The invention relates to wireless telephony systems, and more particularly, relates to Wireless Carriers' LiveTV, Live Music, VoiceMail, Audible GPS and Games subscription services, graphical/touch screen user interfaces and software/hardware architectures for wireless telephony devices.

Today's Wireless Carries are now broadcasting LiveTV, Live Music, VoiceMail, Internet, Games, Audible GPS services to handheld customers. These customers are limited to viewing these services on small displays as installed on the handheld phones. Many handheld owners often use their phones while driving creating unsafe driving conditions. With the vPhone products, drivers will be able to use their phones in a safer environment, view LiveTV, Videos and Music on a larger display screen, and do hands-free voice communication with the built-in speakers and microphones. Watching LiveTV, playing games, surfing the internet with friends and family is very hard when using handheld phones with the smaller display screens traditionally installed. A v³Phone or v³Phone Console will provide a larger display screen for sharing and viewing.

### BRIEF SUMMARY OF THE INVENTION

The invention provides a capability to provide handheld users with devices that will provide larger display screen areas for viewing Wireless Carriers' subscription services such LiveTV, Voicemail, Audible GPS, Internet, Live Music and Games in both vehicular and portable operation modes.

One aspect of the invention is the ability of the vPhone handheld to transferred LiveTV and some or all of its subscription data and functional features to a v³Phone Console vehicular/portable device.

Another aspect of the invention relates to the ability of the v³Phone Console to reconfigure it features and data to each connected vPhone to provide personal communication consoles.

Another aspect of the invention is that the v³Phone Console will supply power to the connected vPhone to preserve the vPhone battery charge.

Another aspect of the invention is the v³Phone which is identical to the v³Phone Console except that it doe not connects to a vPhone for data and functional features. Instead, it is a complete smartphone with a large display screen for vehicular and portable use.

Further features of the invention will become apparent with reference to the following detailed description and accompanying drawings.

### BRIEF DESCRIPTION OF DRAWINGS

FIG. 1 illustrates an example on how the vPhone and the v³Phone Console will interface using an interface cable or wireless means that connects to both the vPhone and v³Phone Console. The interface cable also shows the vPhone being provided power from the v³Phone Console. The drawing also shows a built-in connector on the vPhone to connect to the interface cable. The v³Phone Console also have an optional hidden QWERTY Keyboard feature (not shown). The “Mode” Switch on the v³Phone Console is use to switch unit between “Vehicle Operation Mode” and “Portable Mode.” In the Vehicle Mode, certain features such as the QWERTY Keyboard can be disabled for driver safety. In the Portable Mode, all features of the vPhone Console as transferred from the vPhone will be active. The WebCam is displayed as an optional feature for Video Conferencing for both business and personal use. Webcam, if installed, will have a Zoom feature to zoom in on the subject(s). Featured displayed on the v³Phone Console such as Speakers, Microphone, Function Buttons are self-explanatory and do not display the exact locations for factory designs. Standard and optional accessories are also listed.

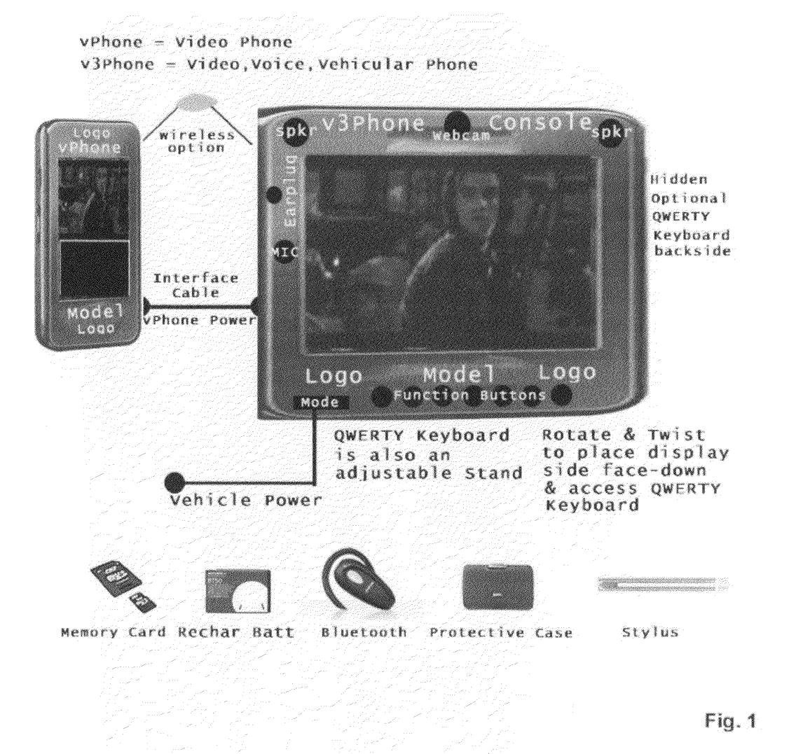

FIG. 2 shows the v³Phone Stand-a-lone unit requiring no need for interfacing with a vPhone because it is a complete handheld/smartphone with a larger size and display screen for vehicular and portable use. Standard and optional accessories are also listed.

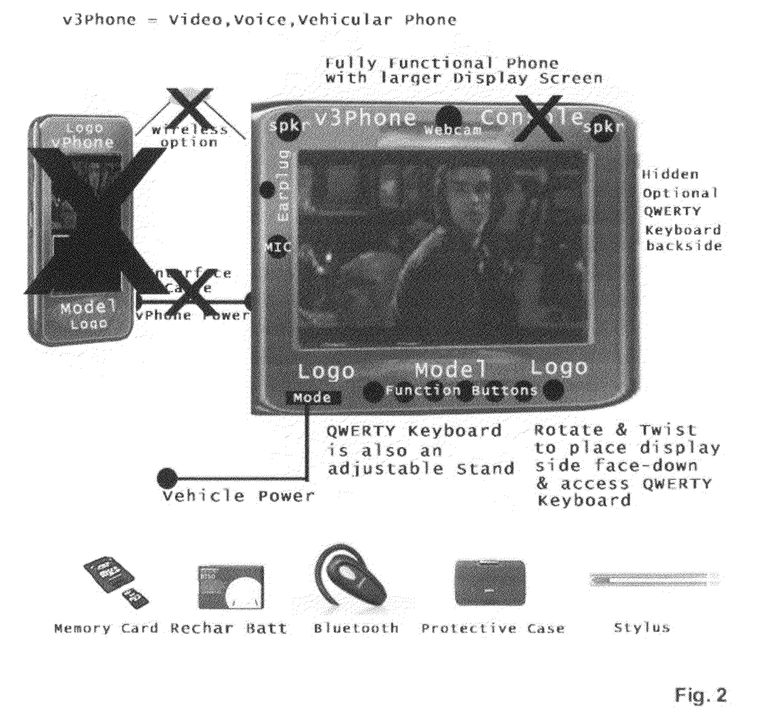

### DETAILED DESCRIPTION OF THE INVENTION

The vPhone Series consist of three major components: vPhone (video phone), v³Phone (video,voice, vehicle phone) and v³Phone Console.

VPhone is a handheld smartphone/cellphone that is capable of receiving LiveTV from a Wireless Carrier, have built-in external connector or wireless capability to interface with a v³Phone Console, and have software, if required, to transfer some or all of its subscription data, functional features and stored data to a v³Phone Console. The external connector and ability to transfer LiveTV data (via interface cable or wireless) to an external device such as a v³Phone Console will be the determining factors for vPhone classifications and this invention. Only handheld/smartphones capable of receiving LiveTV are eligible to manufacture as vphones.

V³Phone Console is a vehicular/portable console that receive some or all of its subscription and functional features data via an interface cable or wireless communication from a vPhone to provide users a larger display screen and all or some of the functional features of the vPhone. V³Phone Console will also provide power to the physical connected vPhone. V³Phone will also have other required electronic components and circuits to ensure it can function as a handheld/smartphone.

V³Phone Console can have all or some of the vPhone functional features. V³Phone Console can be temporarily mounted in vehicles, and removed and used as a portable unit. vPhone user's data will be removed when another compatible vPhone is connected or when the current vPhone is removed. In other words, when vPhone user “A” connects to the v³Phone Console, the v³Phone Console's data, telephone number, voicemail, etc . . . belongs to user “A”. When vPhone user “B” connects to the same v³Phone Console, the v³Phone Console's data, telephone number, voicemail, etc . . . belongs to user “B”. Both users A and B vPhones must be compatible with the v³Phone Console if the Console is Wireless Carrier Specific.

v³Phone is a version of the v³Phone Console but is a stand-a-lone unit with Wireless Carrier SimCard installed to make it a fully functional wireless phone. This version will not interface with vPhones. It can be vehicular mounted and removed for portable use. This version is more suitable for users who desire to have a separate wireless phone number for their vehicular/portable use.

Both the v³Phone and v³Phone Console will be compact, sleek, thin, and lightweight while allowing for a larger display screen. Both can have an optional hidden QWERTY Keyboard, Touch Screen Navigation and the capability to use a Stylus. Also, both versions will have built-in speakers and microphone to allow for hand-free communications. Video Conferencing with a Zoom Webcam will be optional for business and personal use.

v³Phone Console can also be designed to be factory installed in automobiles by automobile manufacturers.

Whatever functional features transferred to the v³Phone Console from the connected vPhone should be fully functional, accessible and usable by the v³Phone Console. In other words, whatever the user can do with the functional features and data using the vPhone can also be done from the v³Phone Console.

Since the v³Phone is basically a larger Handheld/Smartphone, it features are limited to subscription services purchased from Wireless Carriers and manufacture designs.

Although not limited to, the primary use for the vPhone products are to provide Wireless Carriers a mean to offer their advancing service technologies such as LiveTV, VoiceMail, Audible GPs, Internet etc . . . to their customers for vehicular and portable operations with a larger display screen. Auto Manufacturers can also use the Console version as a factory install option.

1. A vPhone (video phone) that can transfer its subscription data, functional features and stored data to a vehicular/portable console (v³Phone) via an external cable or wireless mean (for future technologies). vPhone is a handheld smartphone/cellphone that is capable of receiving LiveTV from a Wireless Carriers, have external connector to interface with a v³Phone Console, and have software, if required, to transfer its subscription data, functional features and stored data to a v³Phone Console or other devices. The external connector and/or the capability to transfer LiveTV data (via interface cable or wireless means) to an external device such as a v³Phone Console will be the determining factors for vPhone classifications and this invention claim.

2. A v³Phone Console that can emulate and/or house some or all the functions and features of a connected/associated vPhone to include Touch Screen Navigation and Control. The v³Phone Console will function as allowed by the connected/associated vPhone and will have a larger display screen (approx 6 to 7 inches) for vehicular and portable use. For drivers' safety, some vPhone features can be disabled during vehicular operations. The purpose of the larger display screen is to provide users a larger viewing area and higher resolution for LiveTV, GPS, Internet, Music, Videos, Voicemail, Games, etc . . . vPhone user's data will be removed when another vPhone is connected/associated with or when the current vPhone is removed. The v³Phone Console will also have a removable Storage Disk for storing movies, music, photos and other data. Will operate on vehicle power and/or a rechargeable battery for portable operation. Speakers and microphone will also be installed for hands-free voice operations such as voice dialing, voicemail, audible GPS, communicating with another party, etc . . . Will feature an optional hidden QWERTY keyboard to provide a large typing area. The v³Phone Console can also have optional Video Conferencing with zooming webcam capability for business and personal applications.

3. A v³Phone, a stand-a-lone version of the v³Phone Console, requiring no external interface connection to a vPhone. This version is a fully functional, large display screen, handheld/smartphone with Wireless Carrier's simcard installed for subscription services. For drivers' safety, some v³Phone features can be disabled during vehicular operations. The purpose of the larger display screen is to provide users a larger viewing area and higher resolution for LiveTV, GPS, Internet, Music, Videos, Voicemail, Games, etc . . . The v³Phone will also have a removable Storage Disk for storing movies, music, photos and other data. Will operate on vehicle power and/or a rechargeable battery for portable operation. Speakers and microphone will- also be installed for hand-free voice operations such as voice dialing, voicemail, audible GPS, communicating with other parties, etc . . . Will feature an optional hidden QWERTY keyboard to provide a large typing area. The v³Phone can also have optional Video Conferencing with zooming webcam capability for business and personal applications.
